(19) United States
(12) Patent Application Publication
(10) Pub. No.: US 2010/0295734 A1
(43) Pub. Date: Nov. 25, 2010

(54) METHOD AND APPARATUS OF USING SOFT INFORMATION FOR ENHANCING ACCURACY OF POSITION ESTIMATION FOR A WIRELESS COMMUNICATION SYSTEM

(76) Inventors: Cheng-Hsuan Wu, Taipei City (TW); Chin-Tseng Huang, Hsinchu City (TW); Yung-Szu Tu, Taipei County (TW); Jiunn-Tsair Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/614,437

(22) Filed: Nov. 8, 2009

(30) Foreign Application Priority Data
May 19, 2009 (TW) 098116548

(51) Int. Cl. G01S 5/02

(52) U.S. Cl. 342/463

(57) ABSTRACT

A method of enhancing accuracy of position estimation for a wireless communication system includes receiving a plurality of input measurements required for estimating a position of a target, and generating a plurality of Gaussian probability density functions corresponding to the plurality of input measurements, the plurality of Gaussian probability density functions being used for estimating the position of the target.

### BACKGROUND OF THE INVENTION

1. Field of the Invention

The present invention relates to a method and an electronic device of enhancing accuracy of position estimation for a wireless communication system, and more particularly, to a method and an electronic device of enhancing accuracy of position estimation for a wireless communication system according to soft information.

2. Description of the Prior Art

Position location (PL) techniques in wireless communication systems are crucial to many applications, emergency system, position-based billing services, the elderly and patients in special care, the target position of fire fighters and soldiers on missions, and etc. Time of Arrival (TOA), Angle of Arrival (AOA) and Received Signal Strength (RSS) are common position location techniques. Time of Arrival-based technique firstly calculates distances between each of three base stations and a target by propagation velocity multiplying propagation time of received signals estimated by the three base stations respectively, takes each of the three base stations as a center of a circle and each of the distances as a radius for drawing circles, and thereby gets the target position by a meeting point of the three circles. Angle of Arrival-based technique determines source directions of received signals estimated by two base stations respectively, takes each base station position as a start point for forming a straight line, and thereby gets the target position by a meeting point of the two straight lines. RSS-based technique utilizes received signal strength estimated by three base stations and pre-constructed signal transmission decay model for obtaining distances between each of the three base stations and the target respectively, takes each base station as a center of a circle and each of the distances as a radius for drawing circles, and thereby determines the target position. In the following description, a wireless communication system which performs position estimation is briefly called a position location system.

Since an indoor environment has complex furnishing and decoration, the radio signal propagation is not line of sight (or called Non-Line of Sight’ NLOS) propagation, and a multipath effect is also quite obviously. The abovementioned TOA-based and AOA-based techniques are particularly affected by the multipath effect, and thereby easily cause errors during estimating the target position. On the other hand, variation of received signal strength is easy to estimate when the target moves, and thereby RSS-based technique are more suitable for indoor position location system than TOA-based and AOA-based techniques.

Indoor position location algorithms using RSS measurements can roughly be divided into two categories: pattern-recognition algorithm and model-based algorithm. In the pattern-recognition algorithm, the target position can be estimated according to received signal strength measurements estimated by the target and received signal strength measurements corresponding to multiple training points, such as RADAR and LANDMARC algorithms. The detailed content can be referred in a paper “RADAR: An in-building RF-based user position and tracking system” in Proc. IEEE INFOCOM 2000, vol. 2, March 2000 and “LANDMARC: Indoor position sensing using active RFID” in PerCom' 03, March 2003. Please refer to FIG. 1, which is a schematic diagram of a wireless communication network 10 according to the prior art. The wireless communication network 10 includes a position location system 100, a target 102, and base stations AP₁-AP₄. In FIG. 1, an indoor environment of the base stations AP₁-AP₄ are defined as a testing area which is divided into multiple equal square training units, and four vertices of each of the training units respectively correspond to training points. When the target 102 has not entered the testing area, each base station performs estimation for obtaining RSS measurements corresponding to each training point position, and transmits those RSS measurements to a position database of the position location system 100. RSS measurements corresponding to the training points are assumed to be error-free. The target 102 reports the RSS measurements corresponding to each base station to the position location system 100 when the target 102 enters the testing area, and then the position location system 100 performs the RADAR or LANDMARC algorithm for extracting the position of the target 102 according to the received RSS measurements.

The RADAR algorithm obtain the position of the target 102 by averaging positions of k training points corresponding to k RSS measurements closest to the RSS measurements transmitted from the target 102 in the position database. However, measurement reliability of the averaged k training points may not be the same, which causes great error between a position location result and an actual target position. The LANDMARC algorithm further distributes different weights to the positions of the k training points, and averages the weighted k training point positions for estimating the position of the target 102. The weight is a Euclidian distance between the RSS measurements transmitted from the target 102 and the RSS measurements corresponding to each of the k training points. However, the Euclidian distance of the received signal strength cannot reflect the geometric distance exactly. In addition, since the RADAR and LANDMARC algorithms do not take measurement errors of the received signal strength into account, the accuracy of position estimation is not improved significantly.

On the other hand, the model-based algorithms calculates distances between the target and the three base stations according to a pre-constructed radio propagation model and estimated received signal strength, and then uses a triangle algorithm to determine the target position. However, the model-based algorithms suffer the following disadvantages: (1) extensive channel measurements are needed to construct the radio propagation model and (2) a “good enough” position dependent RSS based radio propagation model in complex indoor environments is difficult to construct, and hence considerably affected the accuracy of position estimation. In addition to the abovementioned pattern-recognition and model-based algorithms, the indoor position location system can obtain the target position according to a maximum-likelihood algorithm. However, the maximum-likelihood algorithm is not feasible due to high computational complexity, and causes the indoor position location system overload. As can be seen, the abovementioned algorithms do not provides enough accuracy of position estimation.

### SUMMARY OF THE INVENTION

Therefore, the present invention provides a method and an electronic device of enhancing accuracy of position estimation for a wireless communication system.

The present invention discloses a method of enhancing accuracy of position estimation for a wireless communication system. The method includes receiving a plurality of input measurements required for estimating a position of a target, and generating a plurality of Gaussian probability density functions corresponding to the plurality of input measurements for estimating the position of the target.

The present invention further discloses an electronic device of a wireless communication system for executing the abovementioned method, for enhancing accuracy of position estimation for the wireless communication system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication network according to the prior art.

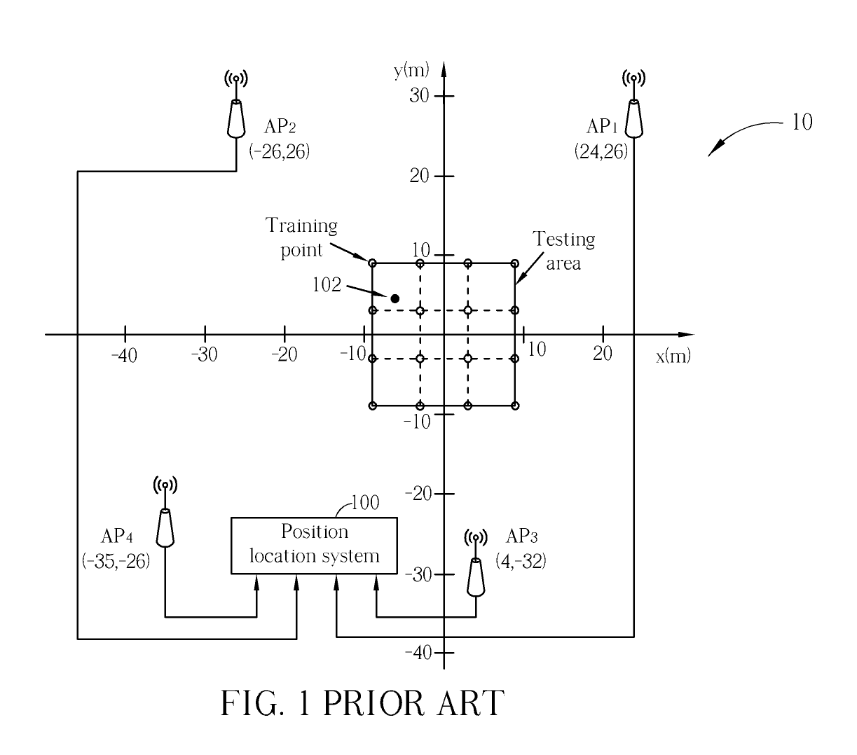

FIG. 2 is a schematic diagram of a process according to an embodiment of the present invention.

FIG. 3 is a graph of a probability density function and a Gaussian probability density function versus a received signal strength measurement according to an embodiment of the present invention.

FIG. 4 is a graph of a mean position error versus standard deviation of a received signal strength measurement error.

FIG. 5 is a schematic diagram of a process according to an embodiment of the present invention.

FIG. 6 is a graph of a mean position error obtained by a position location system using a factor graph of Kalman Filter and Maximum Likelihood algorithm versus time.

### DETAILED DESCRIPTION

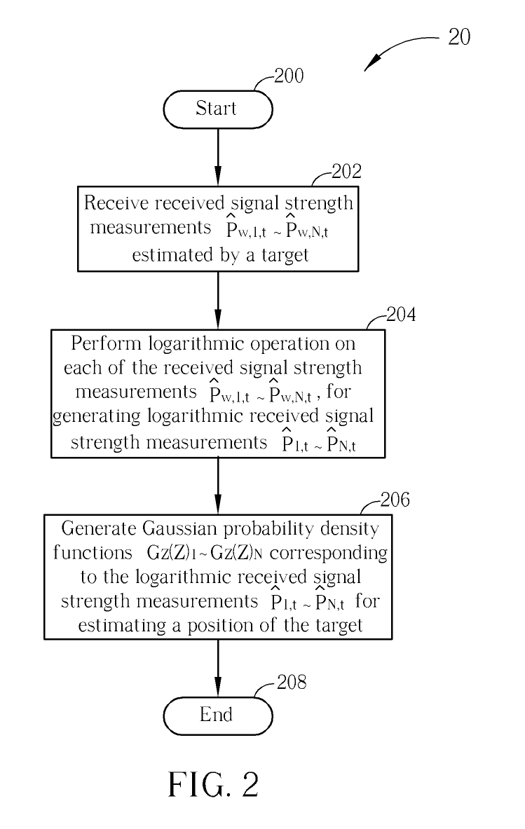

A concept of the present invention is related to an algorithm proposed by an applicant of the present invention in a published paper, “A Novel Indoor RSS-based Position Location Algorithm Using Factor Graph”, disclosed in IEEE TRANSACTIONS ON WIRELESS COMMUNICATION in March, 2009. Please refer to FIG. 2, which is a schematic diagram of a process 20 according to an embodiment of the present invention. The process 20 is utilized in a position location system for improving inaccuracy of position estimation of received signal strength (RSS) based algorithm according to the prior art. In the process 20, the position location system is set in an area which includes base stations AP₁-AP_{N} for detecting a target entering the area and transmitting radio signal to the target. Meanwhile, the position location system receives RSS measurements associated with all the base stations AP₁-AP_{N} and the target. The process 20 includes the following steps:

Step 200: Start.

Step 202: Receive received signal strength measurements \hat{p}_{w,1,t}-\hat{p}_{w,N,t} estimated by a target.

Step 204: Perform logarithmic operation on each of the received signal strength measurements \hat{p}_{w,1,t}-\hat{p}_{w,N,t}, for generating logarithmic received signal strength measurements \hat{p}_{1,t}-\hat{p}_{N,t}.

Step 206: Generate Gaussian probability density functions G_{z}(z)₁-G_{z}(z)_{N} corresponding to the logarithmic received signal strength measurements \hat{p}_{1,t}-\hat{p}_{N,t} for estimating a position of the target.

Step 208: End.

In the process 20, the position location system obtains the position of the target (hereafter called target position) according to the RSS measurements, so the RSS measurements \hat{p}_{w,1,t}-\hat{p}_{w,N,t} are input measurements for the position location system. Each RSS measurements \hat{p}_{w,i,t} of the RSS measurements \hat{p}_{w,1,t}-\hat{p}_{w,N,t} is obtained by the target estimating a radio signal received from a base station APᵢ, and the target transmits the RSS measurements \hat{p}_{w,i,t} to the position location system. Note that, the received signal strength is in units of watts, and the RSS measurement \hat{p}_{w,i,t} corresponding to the base station APᵢ is

\hat{p}_{w,i,t}=\tilde{p}_{w,i,t}+nᵢ, (1)

where \hat{p}_{w,i,t} is the sum of the error-free received signal strength \tilde{p}_{w,i,t} and a measurement error nᵢ. According to step 204, after the position location system receives the RSS measurement \hat{p}_{w,i,t}, the position location system performs logarithm operation on RSS measurement RSSᵢ, for generating logarithmic RSS measurements \hat{p}_{i,t}, so as to generate logarithmic RSS measurements \hat{p}_{1,t}-\hat{p}_{N,t}. The \hat{P}_{i,t} is expressed by the following equation:

\hat{p}_{i,t}=10 log₁₀(\tilde{p}_{w,i,t}+nᵢ). (2)

A reason of the present invention performing logarithm operation on RSS measurement \hat{p}_{w,i,t} is to simplify multiplication and division operations between RSS measurements to addition and subtraction operations. Please note that, the measurement error nᵢ indicates noise of the RSS measurements, which is a Gaussian probability density function with zero mean and variance σ²ₙ_{ᵢ}. Therefore, the logarithmic RSS measurement \hat{p}_{i,t} is expressed as a probability density function ƒ_{z}(z):

$${f}_{z} ( z ) = \frac{( ln 10 ) \cdot {10}^{\frac{z}{10}}}{10 \cdot {σ}_{{n}_{i}} \cdot \sqrt{2 π}} \cdot exp \{ \frac{- {( {10}^{\frac{z}{10}} - {\tilde{p}}_{w , i , t} )}^{2}}{2 {σ}_{{n}_{i}}^{2}} \} , z = {\hat{p}}_{i , t} . \qquad ( 3 )$$

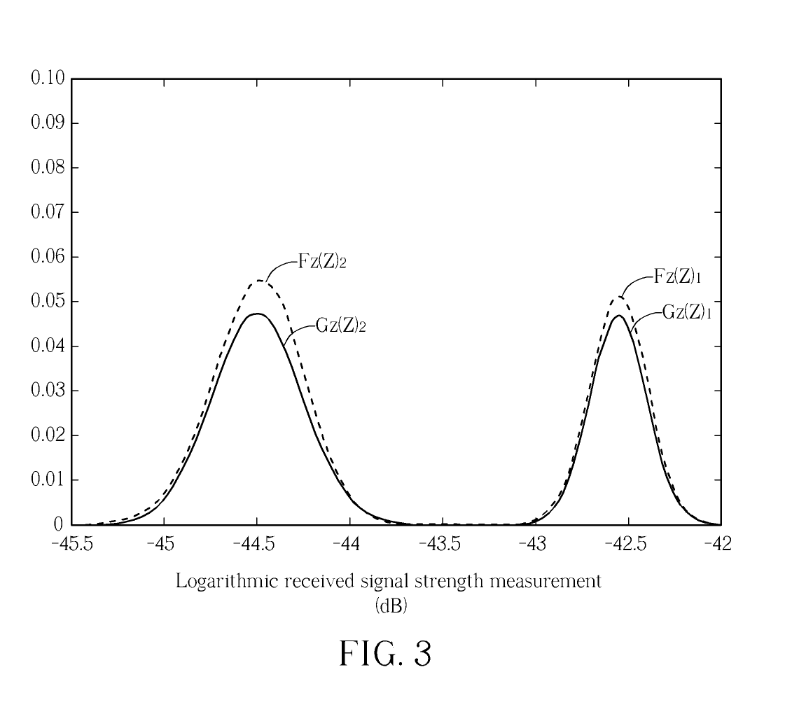

The probability density function f_{z}(z) is not a Gaussian probability density function, but similar to the Gaussian probability density function. Please refer to FIG. 3, which is a graph of the probability density function f_{z}(z) and the Gaussian probability density function G_{z}(z) versus the RSS measurements according to an embodiment of the present invention. The mean and variance of the Gaussian probability density function G_{z}(z)₁ and probability density function f_{z}(z)₁ on the right of the graph are equivalent, which is −42.6 dB. The mean and variance of the Gaussian probability density function G_{z}(z)₂ and probability density function f_{z}(z)₂ on the left of the graph are equivalent, which is −44.6 dB. As can be seen in FIG. 3, the probability density function f_{z}(z) with larger mean reveals smaller variance. On the contrary, the probability density function f_{z}(z) with smaller mean reveals larger variance. Characteristics of the abovementioned functions illustrates that the RSS measurements corresponding to a closer base station is more reliable than RRS measurement corresponding to a longer base station during performing position estimation.

In the prior art, shortcomings of the RADAR algorithm is that reliability of each training point position may not be the same. Although a position result derived from the LANDMARC algorithm is more accurate than the RADAR algorithm, the weight used in the LANDMARC algorithm cannot exactly reflect geometric distance. In comparison, based on characteristics of the probability density functions shown in FIG. 3, if the target position is estimated according to the RSS measurements in a probability density function form, so called soft information of RSS measurements, the reliability of the RSS measurements is considered, and thereby the position estimation is more accurate than the LANDMARC algorithm. Besides, as can be seen in FIG. 3, the Gaussian probability density function G_{z}(z) is similar to the probability density function f_{z}(z), and an advantage of the Gaussian probability density functions is that after multiple Gaussian probability density functions perform addition and subtraction operation to each other, an operation result is still a Gaussian probability density function. According to the above reasons, in step 206, the position location system generates the Gaussian probability density functions G_{z}(z)₁-G_{z}(z)_{N} corresponding to the logarithmic RRS measurements \hat{p}_{1,t}-\hat{p}_{N,t} based on the probability density function f_{z}(z)₁-f_{z}(z)_{N}, for estimating the target position.

In other words, the process 20 generates the Gaussian probability density functions corresponding to the input measurements, and thereby the position location system can improve the conventional method which directly utilizes RSS input measurements for estimating position according to the process 20, so as to enhance accuracy of position estimation. For example, the algorithm proposed by the applicant of the present invention in an essay, “A Novel Indoor RSS-based Position Location Algorithm Using Factor Graph”, utilizes a factor graph for position estimation, and the Gaussian probability density functions generated by the process 20 is utilized in the factor graph.

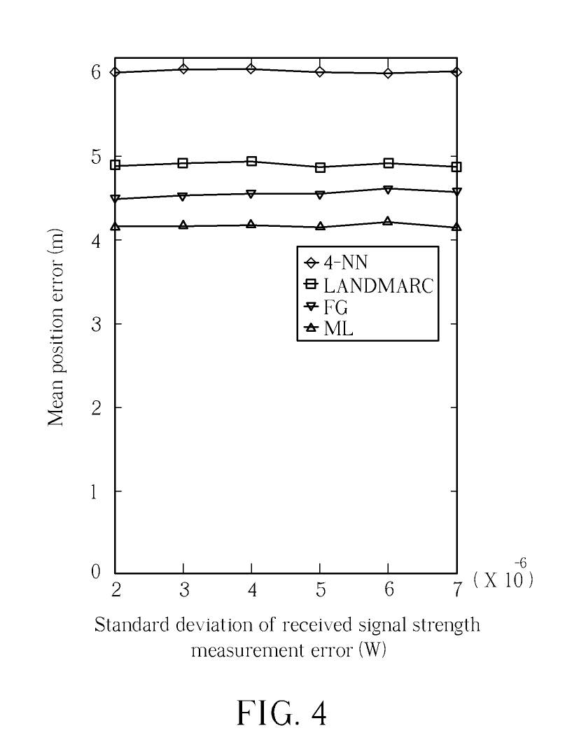

Please refer to FIG. 4, which is a graph of a standard deviation of the RRS measurement error nᵢ versus a mean position error obtained by the position location system according to the algorithm of the abovementioned essay proposed by the applicant of the present invention, hereafter called FG, 4-NN (4 Nearest Neighbor) algorithm (which is similar to RADAR algorithm), LANDMARC algorithm, and maximum likelihood (ML) algorithm, where a range of the standard deviation σₙ_{ᵢ} is from 2×10⁻⁶ W to 7×10⁻⁶ W. The measurement error derived from the algorithm in the abovementioned essay proposed by the applicant of the present invention is significantly smaller than the measurement error derived from the 4-NN and LANDMARC algorithms, and is close to the lowest measurement error of maximum likelihood algorithm. As can be seen from the above, the Gaussian probability density functions used for estimating the target position can enhance accuracy of position estimation effectively.

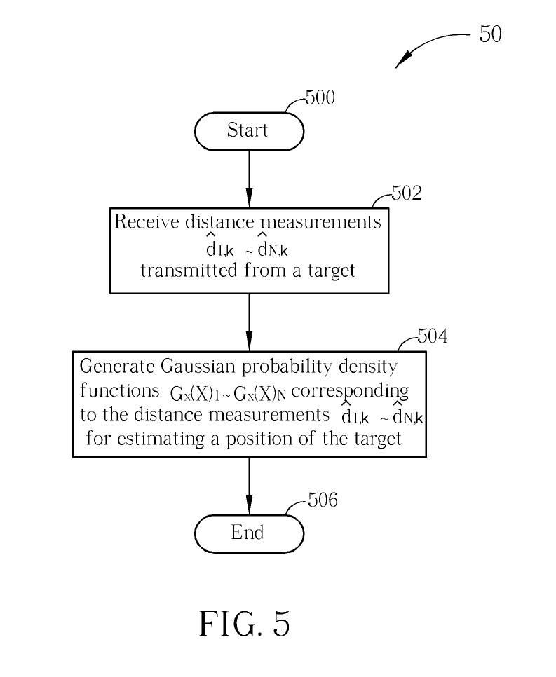

Please refer to FIG. 5, which is a schematic diagram of a process 50 according to an embodiment of the present invention. The process 50 is utilized in the position location system for improving inaccuracy of position estimation of Time of Arrival-based algorithm according to the prior art. The process 50 includes the following steps:

Step 500: Start.

Step 502: Receive distance measurements \hat{d}_{1,k}-\hat{d}_{N,k} transmitted from a target.

Step 504: Generate Gaussian probability density functions G_{z}(z)₁-G_{z}(z)_{N} corresponding to the distance measurements \hat{d}_{1,k}-\hat{d}_{N,k} for estimating a position of the target.

Step 506: End.

In the process 50, the position location system estimates the target position according to the distance measurements. For the position location system, the distance measurements \hat{d}_{1,k}-\hat{d}_{N,k} is input measurements, each distance measurement \hat{d}_{i,k} is an estimated distance between the target and one of the base stations AP₁-AP_{N}, which is expressed as the following equation:

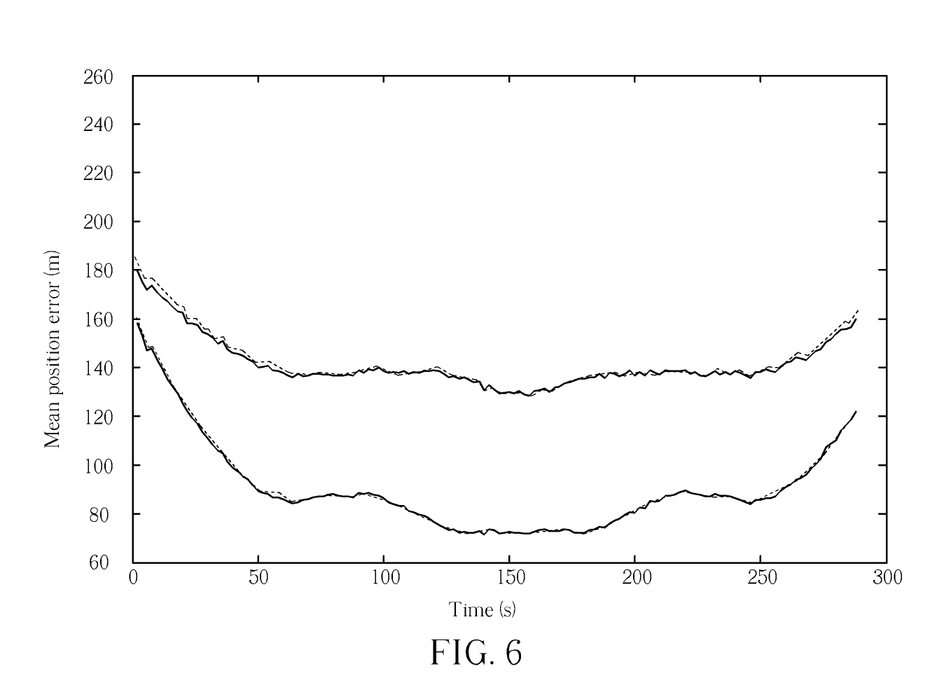

\hat{d}_{i,k}=d_{i,k}+e_{i,k}+e_{NLOS,i,k}, (4)

where k indicates the k^{th} sampling time, e_{i,k} indicates measurement distance error of Line of Sight (LOS), which is a Gaussian probability density function with zero mean and variance σ²_{d}_{_{i,k}}, e_{NLOS,i,k} indicates measurement distance error of Non-Line of Sight (NLOS), which is a Gaussian probability density function with non-zero mean and variance σ²_{NLOS}. The distance measurement \hat{d}_{i,k} is indicated as a probability density function fₓ(x), where x=\hat{d}_{i,k}. Similar to the abovementioned characteristic of the probability density function fₓ(x) of the logarithmic RSS measurement \hat{p}_{i,t}, the probability density function fₓ(x) of the distance measurements is also approached to a Gaussian probability density function Gₓ(x). Therefore, in step 504, the position location system generates the Gaussian probability density functions Gₓ(x)₁-Gₓ(x)_{N} corresponding to distance measurements \hat{d}_{1,k}-\hat{d}_{N,k} based on the Gaussian distribution approached to the probability density functions fₓ(x)₁-fₓ(x)_{N}. Moreover, the position location system can use Gaussian probability density functions Gₓ(x)₁-Gₓ(x)_{N} in a factor graph based on the Time of Arrival-based algorithm, such as a factor graph of Kalman Filter, for determining the target position. Please refer to FIG. 6, which is a graph of an average position error obtained by the position location system using a factor graph of Kalman Filter and Maximum Likelihood algorithm versus time, wherein the dotted line indicates a curve obtained by using the factor graph of Kalman Filter, and the solid line indicates a curve obtained by using the Maximum Likelihood algorithm. In FIG. 6, the curve with larger error is a case without considering the input measurement being soft information, and the curve with smaller error is obtained by applying the process 50. As can be seen, the present invention can improve position estimation error significantly, to enhance the accuracy of position estimation.

Note that, the factor graph is only a kind of the graphical model, which indicates relations between multiple random variables in a manner of graph. Therefore, the Gaussian probability density functions generated by the processes 20 and 50 of the present invention are not limited in the factor graph, which also can be used in other graphical models, such as Normal Graph or Tannar Graph. In the wireless communication network, the base station and the position located target are defined according to different demands, and thereby for hardware realization, the position location system can be installed independently, or installed on the side of the base station or the target. For example, for a Global Position System, the base station is a positioning satellite, the target is a navigation device or a received antenna, and the positioning system is usually installed on the side of the target. For a wireless local area network, base station is a wireless network access point, the target is a wireless network card or a related network device, and the positioning system is usually installed on the side of the target. For a radio frequency identification (RFID) system, a radio frequency identification reader is a base station, a radio frequency identification tag is a target, and the positioning system can be installed on the side of the base station or installed independently. Please note that, the present invention can significantly improve inaccuracy of position estimation caused by multipath effect. Therefore, the present invention is more suitable utilized in the indoor position location system, but not limited in the indoor position location system.

In conclusion, the present invention takes the measurement reliability of the input measurements into account for calculating the target position in the position location system, and generates the Gaussian probability density functions corresponding to the input measurements for performing position calculation. Therefore, the present invention can enhance accuracy of position estimation of the RSS-based algorithm, TOA-based, or other position location techniques.

Those skilled in the art will readily observe that numerous modifications and alterations of the device and method may be made while retaining the teachings of the invention.

What is claimed is:

1. A method of enhancing accuracy of position estimation for a wireless communication system comprising:
receiving a plurality of input measurements; and
generating a plurality of Gaussian probability density functions corresponding to the plurality of input measurements for estimating a position of a target.

2. The method of claim 1, wherein a type of the plurality of input measurements is received signal strength.

3. The method of claim 1, wherein the step of receiving the plurality of input measurements comprises receiving a plurality of received signal strength measurements estimated by the target, each received signal strength measurements corresponds to a base station.

4. The method of claim 3, wherein the step of generating the plurality of Gaussian probability density functions corresponding to the plurality of input measurements comprises:
performing logarithmic operation on each of the plurality of received signal strength measurements, for generating a plurality of logarithmic measurements; and
generating the plurality of Gaussian probability density functions corresponding to the plurality of logarithmic measurements.

5. The method of claim 1, wherein a type of the plurality of input measurements is distance.

6. The method of claim 1, wherein the step of receiving the plurality of input measurements comprises receiving a plurality of distance measurements transmitted from the target, each distance measurement is a distance between the target and one of a plurality of base stations.

7. An electronic device of a wireless communication system for executing the method of claim 1, for enhancing accuracy of position estimation for the wireless communication system.
